(19) United States
(12) Patent Application Publication
(10) Pub. No.: US 2009/0216501 A1
(43) Pub. Date: Aug. 27, 2009

(54) System and apparatus for vicinity and in-building visualization, planning, monitoring and exploring

(76) Inventors: Shin We Yeow, Singapore (SG); Tong Wing Woon, Singapore (SG); Bee Pel Tan, Singapore (SG)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/887,061

(22) PCT Filed: Mar. 24, 2005
(86) PCT No.: PCT/SG2005/000097

§ 371 Date: Jan. 20, 2009

(51) Int. Cl. G06F 17/50; G06F 3/048

(52) U.S. Cl. 703/1; 715/771; 715/851

(57) ABSTRACT

The present invention is a method and system of planning, monitoring and exploring the interior and vicinity of a building or an infra-structure utilizing a computer. The method provides a GUI that optimizes the limited screen space of the computer to provide important functions and toolsets to design scenarios for applications in planning, monitoring and exploring infra-structures. In a scenario, the user can incorporate assets into the application, link the assets to physical setup such as CCTV or positioning devices for monitoring, animate the assets to understand the inter-play of assets for planning, and locate assets for exploring infra-structures.

### FIELD OF THE INVENTION

The presented invention relates generally to computer graphics, and more particularly, to systems and apparatuses for interactive user control in planning, monitoring and exploring infrastructures.

### BACKGROUND OF THE INVENTION

There are various occasions where one needs to plan, or monitor or explore the interior of a building. We shall use “building” to also refer to generally any infrastructure. These may include, for example, tasks in crisis management, security management, event management, asset management and directory/location management, within and around the vicinity of a building. These tasks appear in industries such as homeland defense and public safety; healthcare; building, campus and critical installation management and security; data center management; event management of key parades, sporting events etc; warehouse automation; directory solutions for public amenities and tourist locations.

The current approach and prior art systems were deficient in providing a comprehensive vicinity and in-building visualization with the appropriate user interfaces and controls to ease the effort in performing these tasks by diverse groups of users.

In planning, monitoring or exploring a building, one uses the technical floor plans or drawings of the building to perform the task. As such, there are issues in interpreting these drawings to extract useful information to perform the task. Expert and highly skilled users such as architects or building contractors are capable of such extraction. On the other hand, the task can also involve personnel who are not trained to read or work with such technical drawings. They may be business managers or casual visitors who need to understand the spatial arrangement within and around the building. Thus, technical floor plans, in the current way of presentation, are inadequate to address needs of these diverse groups of users in the planning, monitoring and exploring a building.

With the advance of information technology, floor plans are now available in digital, i.e. softcopy, form as stored in, for example, a computer storage. Computer software applications are available to retrieve and manipulate such softcopies of floor plans. These floor plans are sometimes constructed to present 3D view of the building. However, such prior art systems are not designed with the appropriate user interfaces and controls to ease the effort in performing the abovementioned tasks. For example, AutoCad® by Autodesk Inc. is a general drafting tools for draftsmen to create a precise model of a building. It does not have features to support tasks of, for example, planning an event so as to trial run the movement of personnel within the building. For another example, DesignWorkshop® by Artifice Inc. is a family of the leading software power tools for creating architectural 3D models, renderings, and walkthroughs, from initial sketches to polished presentations. However, it does not support the incorporation of diverse forms of assets used in planning, monitoring and tracking. Such assets in the context of, for example, an airport are security guards, buggies, trolleys, kiosks, luggage, location markers, etc.

In short, all prior art systems do not optimize on the effective use of the limited computer screen space (such as 1024×1280 pixels) to present a graphical user interface with the necessary controls and functions to perform tasks of planning, monitoring and exploring within and around the vicinity of buildings to meet the need of diverse groups of users in an application. On the other hand, it is also challenging and nontrivial to design a comprehensive yet effective controls and functions to ease users working on these tasks.

There is therefore a need to provide a method and system for planning, monitoring and exploring within and around buildings, which can facilitate a more intuitive user interaction to meet the need of diverse groups of users in an application.

### SUMMARY OF THE INVENTION

The invention described herein satisfies the above-identified needs and overcomes the limitations of the prior art systems. The present invention describes a new system and method for vicinity and in-building visualization with applications to effectively plan, monitor and explore buildings. Specifically, disclosed herein is a method implemented as computer software that has a graphical user interface (GUI) optimizing the use of screen space in its presentation of functions and features to support planning, monitoring and exploring buildings. Such GUI includes functions and features to effectively deal with different levels/floors of a building, layers (such as ceiling, fire sub-panel, exterior wall, etc.), assets (such as vehicles, personnel, location markers, etc.), queries on assets, navigation and cross-section views in and around the building, scribbling on objects etc.

The method and system enables users to visualize and manage plans, live situations, on-going workflows within the vicinity and in-building premises. it dramatically enhances the effective and decisive action/response of users, through holistic depiction of the security/resource plans and situations within and around premises. Specifically, the key benefits of our method and system are, for example:

(i) Effective Interpretation of floor plans. Users, such as fire rescue commanders or event planners, are able to interpret and extract embedded information in complicated floor plans effectively enough to perform their tasks, without having to be trained architects or engineers.

(ii) “Off-site” building study. Instead of having to physically survey an actual site, user can instead use our method and system to interactively discuss, study and plan events and operations around their building/area of interest from their offices or boardrooms, thus saving considerable time.

(iii) Optimized workflow. The capability to plan, simulate, present and monitor/command in one solution system optimizes the workflow significantly in a way that can save time, effort, money and even lives.

(iv) Knowledge management and business continuity. The ability to organize building/area data and scenario/plan data into repositories enable organizations to create a knowledge base that can be tapped into by different generations of personnel for re-use or referencing. (v) Integrated operations. The method and system allow integration with peripheral (e.g. temperature monitoring sub-system, CCTV sub-system) and infra-structural (e.g. GPS and wi-fi networks) sub-systems for “live” operational uses, such as tracking and locating assets or alerting of special situations within the multiple levels of a building.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The presented invention will become more fully understood from the detailed description given hereinafter and the accompanying drawings which are given by way of illustration only, and thus are not limitative of the present invention, and wherein:

FIG. 1 is a block diagram of an exemplary raster graphics system;

FIG. 2 is a simplified diagram of a graphics processing system according to an embodiment of the invention;

FIG. 3 is an example of the graphical user interface (GUI) in the embodiment of the invention that optimizes the limited screen space in presenting functions and features to support planning, monitoring and exploring buildings;

FIG. 4 is an example of a Dopesheet window that is used for editing of animation tracks;

FIG. 5 is an example when both the Working Panel and the Tool Panel are hidden to maximize the viewing area of the Main View;

FIG. 6 is an example deployment of security forces for a target building in an urban vicinity using the exemplary GUI in the embodiment of the invention;

FIG. 7 is an example tracking of security personnel within a multi-level building using the exemplary GUI in the embodiment of the invention;

FIG. 8 is an example query feature with mouse using the exemplary GUI in the embodiment of the invention;

FIG. 9 is an example exploring capability to locate shops, items and facilities within public premises using mainly the main view, 2D floor plan view and specialized menu plug-in in the exemplary GUI in the embodiment of the invention;

FIG. 10 is an example deploying security resources visually by dragging icons from the Asset Picker Control using the exemplary GUI in the embodiment of the invention;

FIG. 11 is an example airport scenario using the exemplary GUI in the embodiment of the invention;

FIG. 12 is a Navigation Control in the exemplary GUI in the embodiment of the invention;

FIG. 13 illustrates the plane tool (with Plane 1 and Plane 2 in action) in the Cross-section panel in the exemplary GUI in the embodiment of the invention;

FIG. 14 illustrates the monitoring of CCTVs (with views captured within three rectangles) of an convention building in the exemplary GUI in the embodiment of the invention; and

FIG. 15 is a flowchart that depicts the operation of the method and system of the example embodiment.

### DETAILED DESCRIPTION OF THE INVENTION

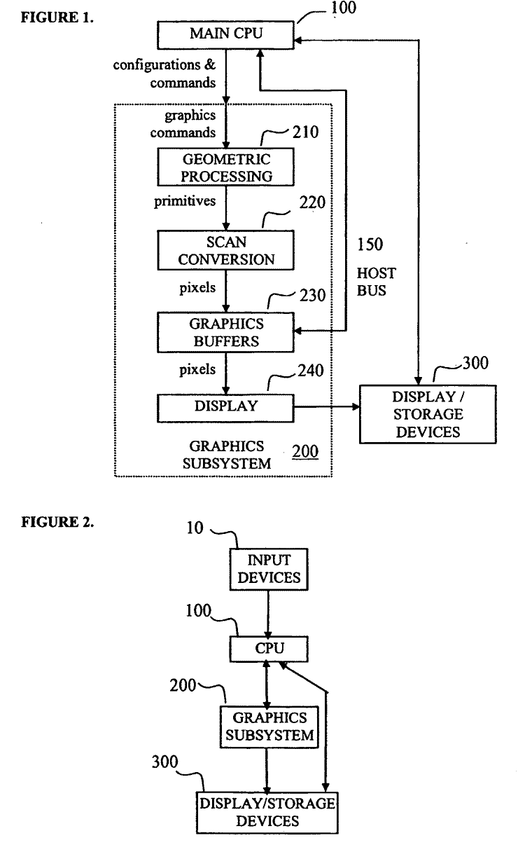

FIG. 1 illustrates an exemplary raster graphics system that includes a main (Host) processor unit 100 and a graphics subsystem 200. The Host processor 100 executes an application program and dispatches graphics tasks to the graphics subsystem 200. The graphics subsystem 200 outputs to a display/storage device 300 connected thereto.

The graphics subsystem 200 includes a pipeline of several components that perform operations necessary to prepare geometric entities for display on a raster display/storage device 300. For the purposes of describing the invention, a model of the graphics subsystem is employed that contains the following functional units. It should be realized that this particular model is not to be construed in a limiting sense upon the practice of the invention.

A Geometric Processor unit 210 performs geometric and perspective transformations, exact clipping on primitives against screen (window) boundaries, as well as lighting computations. The resulting graphics primitives, e.g. points, lines, triangles, etc., are described in screen space (integral) coordinates.

A Scan Conversion (Rasterization) unit 220 receives the graphics primitives from the geometric processor unit 210. Scan converter unit 220 breaks down the graphics primitives into raster information, i.e. a description of display screen pixels that are covered by the graphics primitives.

A Graphics Buffer unit 230 receives, stores, and processes the pixels from the Scan Conversion unit 220. The graphics buffer unit 230 may utilize conventional image buffers and a z-buffer to store this information.

A Display Driver unit 240 receives pixels from the Graphics Buffer unit 230 and transforms these pixels into information displayed on the output display device 300, typically a raster screen.

FIG. 2 is a simplified diagram of a graphics processing system according to the invention. An input device 10 (such as keyboard, mouse, pens, etc.) inputs graphics data and user commands to be processed by the invention. The CPU 100 processes the input data from input devices 10 by executing an application program. CPU 100 also dispatches graphics tasks to the graphics subsystem 200 connected thereto. The output results may then be stored and/or displayed by display/storage devices 300.

Having described an exemplary graphics processing system that is suitable for use in practicing the invention, a description is now provided of a method implemented as software that has a graphical user interface (GUI) optimizing the use of screen space in its presentation of functions and features to support planning, monitoring and exploring buildings.

### Overview of the Method and System

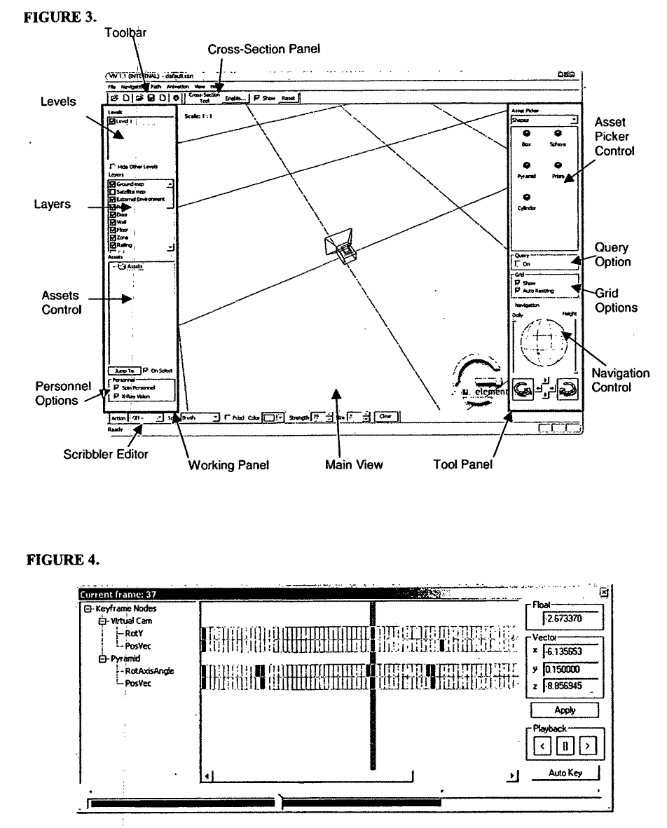

FIG. 3 illustrates our exemplary GUI in the embodiment of the invention that optimizes the limited screen space in presenting functions and features to support planning, monitoring and exploring within and around buildings. It consists of the following major views available to users: (1) Main View, (2) Working Panel (containing levels, layers, assets control, and personnel options), (3) Tool Panel (containing asset picker control, query option, grid options, and navigation control), (4) Toolbar (containing scene open and reset, and scenario open, save and reset), (5) Scribbler Editor (containing action, tool, and color, strength, size of tool, and clear option), (6) Cross-section Panel (containing tool, enable, show and reset option), (7) Dopesheet Window (available as a separate window as shown in FIG. 4. upon activation), and (8) Standard Menu (second row from the top repeating some of the functions available in the above views).

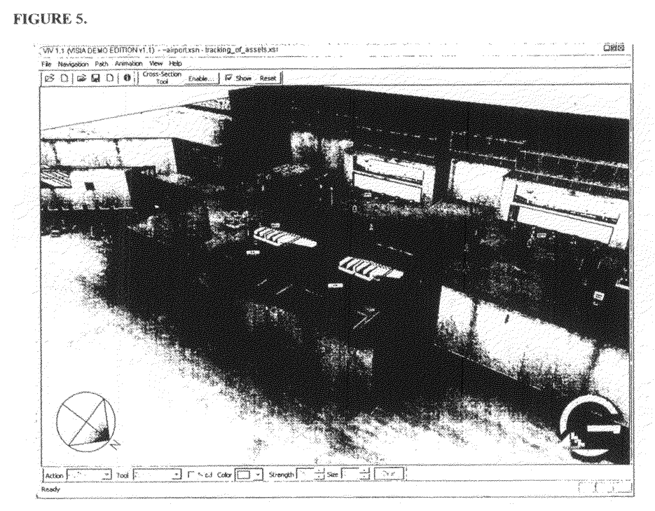

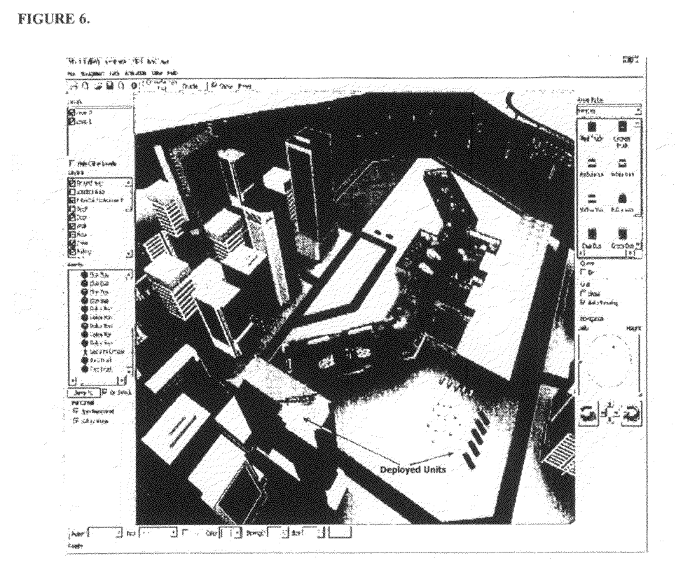

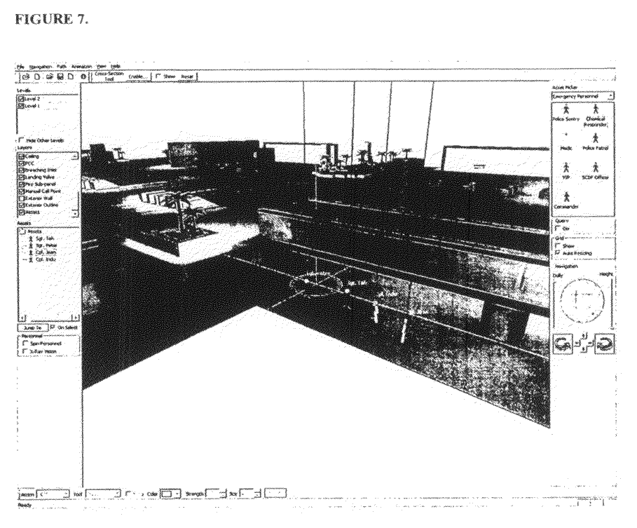

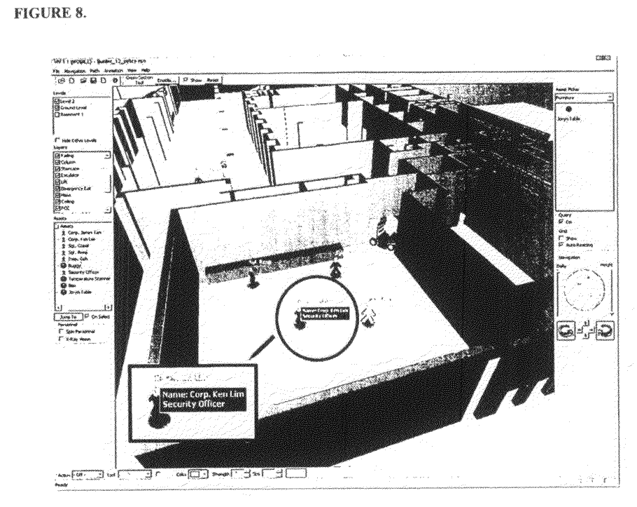

Except for the Main view, all views can be displayed or hidden as needed for an application or as specified by a user. FIG. 5 shows an example when both the Working Panel and the Tool Panel are hidden to maximize the viewing area of the Main View. On the whole, the GUI allows users to do vicinity visualization (as shown in FIG. 6), in-building visualization (as shown in FIG. 7), query (as shown in FIG. 8), navigation, scribbling, asset management, path editing, animation/playback, loading of scene, and loading/saving of scenario.

### Important Notions Used in the Invention

A scene refers to a static model of the physical world in 3D. Typically, a basic scene contains a ground map (“ground map”) and/or a satellite map (“satellite map”), a building with detailed indoor elements (“primary building”), and a number of surrounding external buildings (“external environment”). A scene may optionally feature scenario objects or assets.

A scene is partitioned into layers, which represent groupings of scene objects with similar characterization. For example, all the geometry that defines walls will be grouped under the Wall layer. Layers can be customized from project to project, depending on the needs of an application. For a scene of an airport, the layers, for example, are: ground map, satellite map, external environment, roof, door, wall, floor, zone, railing, column, staircase, escalator, lift, etc. The most common layers are structural elements of a building (columns, walls, staircases, etc.) and scene element (ground map, external environment, assets, etc.).

In addition to layers, the primary building is also grouped by levels, or floors. Levels can be customized from project to project, depending on the needs of an application. For a scene of an airport, the levels, for example, are: ground level, concourse level, shopping level, platform level 1, platform level 2, etc. Note that active level is the level that is currently the focus of the user's inspection and editing.

Scenario resources refer to the collection of items or objects that can be planted in the scene for purposes of planning, monitoring, and exploring within and around the primary building. These are customized from project to project, depending on the needs of an application. Scenario resources are templates of objects and can be made into assets within a scene. In other words, assets are the actual objects or instances made from the templates of scenario resources that have individualized properties like names and positions. Assets may be organized hierarchically into groups.

A scenario represents a user-created plan for purposes of planning, monitoring, and exploring the primary building. Unlike the scene, which is generally static and immutable, a scenario can be edged, saved and reloaded. A number of scenarios may exist for a scene. A scenario can include assets (their locations, orientations, names) and asset groups (their names, hierarchies), animation of assets, and animation of cameras (motion path flags).

In the real world, we use a camera as a device for image acquisition. The viewfinder of a camera provides a preview of what we are looking at. The view behind the viewfinder is analogous to what we see in the Main View of the GUI. We shall adopt the term scene camera to refer to the virtual camera that provides (in general, most of) the Main View view.

### Views of GUI

With the above notions, we are now ready to discuss in details the preferred embodiment of the above available views of the GUI and their purposes. Changes, exchanges, modifications, and embodiments obvious to one skilled in the art given the within disclosures, are within the scope and spirit of the present invention.

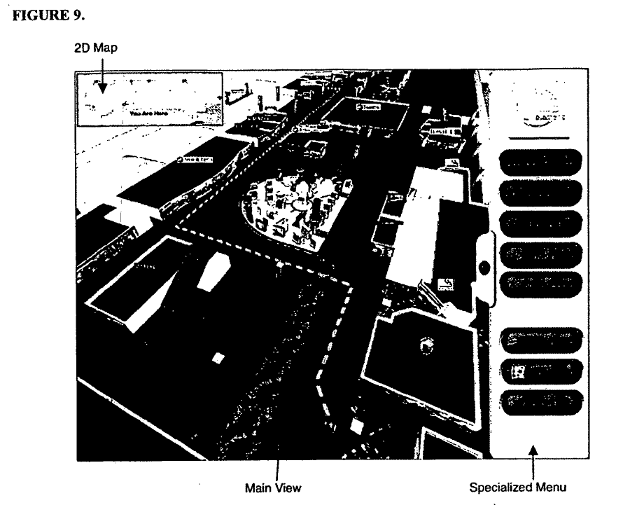

(1) Main View. This view is primarily the view as seen with the scene camera. Scene camera can be manipulated to navigate around the scene. For some application, the Main View may incorporate a 2D floor plan of the scene and specialized plug-in menu in part of the view as shown in FIG. 9. In addition, one can do measurements in the scene.
(2) Working Panel. The Working Panel consists of a collection options in setting levels, layers and assets to be captured in the scene camera.

In particular, the Working Panel has a Level Control where each level can be toggled on and off individually to show or hide them from the scene camera when necessary. This is useful to show just the required levels in order to clearly illustrate specific information on the levels, without being distracted by the presence of other levels. The Level Control also allows the selection of active level that is currently the focus of the user's inspection and editing of the scenario. Active level is highlighted in the Level Control. Planting of new assets, scribbling, and first-person navigation all take place on the active level. Also, floor grid is drawn on the active level if it is turned on.

The Working Panel further has a Layers Control where each layer can be toggled on and off individually to show or hide them from the scene camera when necessary. This is useful to show just the required layers in order to clearly illustrate specific information on the layers, without being distracted by the presence of other layers.

The Working Panel further has an Asset Control where assets can be named and organized hierarchically into groups. It also allows inspection of an asset by clicking on the asset to position the scene camera pointing to the asset. Assets can also be edited with other properties or deleted when no longer needed.

The Working Panel further has options to display assets in some preferred way for specialized resources such as the personnel resource, which may be viewed through obscuration by enabling the X-ray Vision option, or animated by enabling the Spin Personnel option.

(3) Tool Panel. The Tool Panel consists of a collection of tools in setting up a scenario.

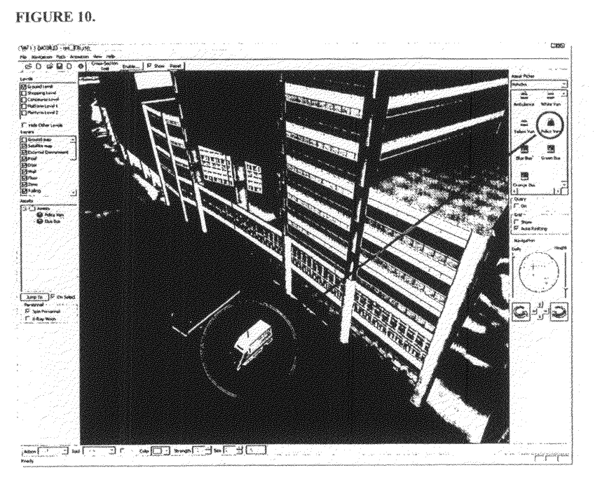

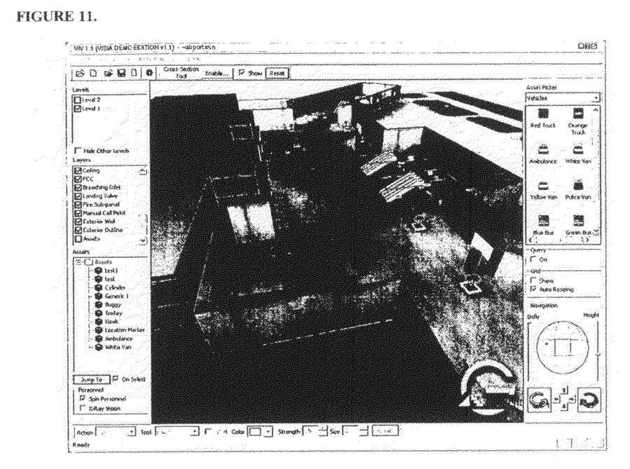

In particular, the Tool Panel has an Asset Picker Control that provides a library of scenario resources to be dragged into the Main View as assets in a scenario (as shown in FIG. 10). Scenario resources are divided into categories to allow ease of selection to be planted as assets in a scenario. For a scene of an airport (such as shown in FIG. 11), the categories, for example, are: airport objects (such as buggy, trolley, generic luggage, kiosk, location marker), security surveillance (such as temperature scanner, CCTV), airport personnel (such as security officer, medic, passengers, etc.), vehicles, and aircraft (such as 747-400, 747-200, 737, etc.).

Assets created from dragging resources in Asset Picker Control are displayed in the Asset Control where manipulation and editing can be performed. An asset's placement in the scene is determined by its Transform, which can be broken down into its 3D position and orientation. While the user generally does not have to consider an asset's Transform in numerical terms, he/she may be required to do so when editing the animation track of an asset.

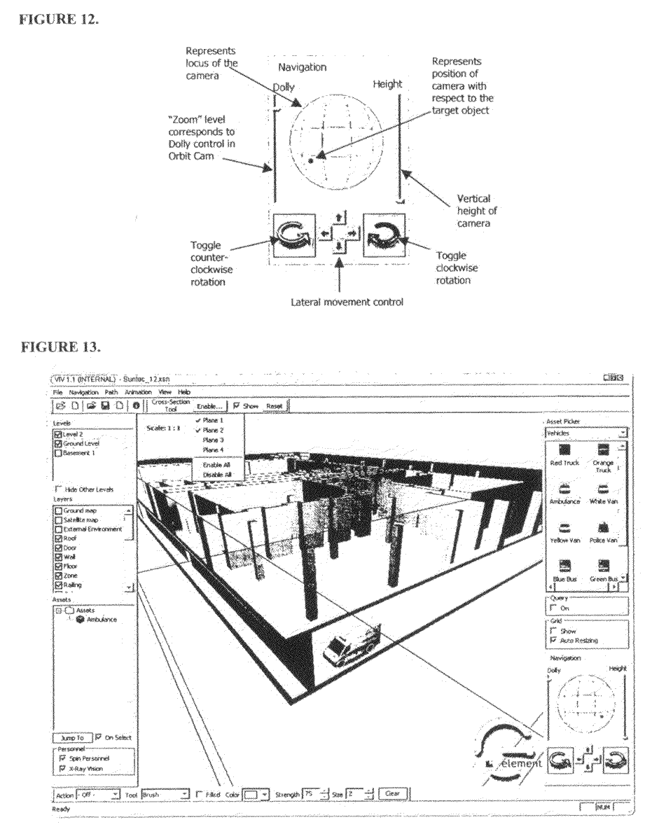

The Tool Panel further provides a comprehensive Navigation Control as shown in FIG. 12 to control the scene camera in orbit mode by using mouse alone for interaction. Besides orbit mode, the scene camera may be operating in flight mode and first-person mode. A mode can be activated (such as by pressing some function key) depending on the need of the user.

In orbit mode, the scene camera is positioned at a distance from an imaginary target. This mode is designed to allow user to inspect objects by placing the target near the objects in question, then orbiting the camera around the target (hence the term orbit mode). The locus of the scene camera's orbit thus forms a hemisphere around the target.

The orbit camera works on the “pull” concept. Think of the mouse cursor as a virtual “hand” grabbing the scene when the user click on it and “pull” it around.

In orbit mode, the user can also modify the distance of the scene camera from the target. This is known as dollying. Dollying has the effect of scaling the objects in the scene.

The user can also move the imaginary target up and down, and thus bring the scene camera along.

The Navigation Control can further provide function to toggle between clockwise and counter-clockwise rotation of the scene.

In flight mode, the scene camera behaves as though It were an aircraft in flight. The scene camera starts out stationary in flight mode. The user may control the speed and orientation (in terms of yaw, pitch and roll) of the camera through mouse movements. For instance, vertical mouse movement may control the speed and pitch of the camera while horizontal movement may control both roll and yaw simultaneously to simulate a sideway turn. The scene camera may gradually restore the roll after a turn.

First-person mode represents the view that a person would see if he or she were to be physically transported into the scene. The eye point of a first-person camera is set at some default value, such as 1.7m. The camera is always clamped to the active level. The user may, through keyboard and/or mouse actions, move the camera like a virtual character through the scene, change the active level, or simply look around from a fixed position.

The Tool Panel further provides options to query levels, layers, and assets within the scene and the scenario (as shown in FIG. 8). In addition, the Grid Options sub-panel allows the user to display a wireframe grid on the active level. This is to provide a frame of reference and is meant to help the user visualize better when planting assets. Optionally, the grid may be set to auto-resizing so that the grid is drawn at the appropriate scale (for example, 1:1, 1:100, etc.) depending on the zoom distance.

(4) Toolbar. The Toolbar consists of functions to open a scene, re-set a scene, open a scenario, save a scenario, or re-set a scenario.
(5) Scribbler Editor. The Scribbler Editor presents tools to perform annotation in a scene by drawing. Scribbling occurs on the active level only, if there are surfaces that allow scribbling. Various forms of scribbling can be provided. Using a brush, the user may scribble freely on pre-specified surfaces in the scene. The user may also mark out an area using line/circle/polygon. Other actions that may be performed include erasing and hiding of the scribbled contents.
(6) Cross-section Panel. The Cross-section Panel presents tools to cull away a part of the scene so that the scene camera can present views in the Main View that are normally obscured or occluded.

One example tool in the Cross-section Panel is the Plane Tool as illustrated in FIG. 13. This tool allows part of the scene in front of the plane to be removed so that the scene camera can view the cross-section of the multi-floors of the building. The user may manipulate the planes interactively to reveal different parts of the building as required.

Another example is the Spot Tool in the Cross-section Panel. This allows the specification of asset of interest and range-of-interest around the asset, and then removes the part of the scene between the scene camera and the asset of interest (excluding the asset) for the scene camera. In this way, the scene camera can present the asset (and part of the surrounding of the asset) in the Main View unobstructed. There are various ways to remove the part of the scene between the scene camera and the asset of interest. In one embodiment, the method first constructs a bounding volume enclosing the asset of interest and region around the asset of size as defined by the range-of-interest around the asset. The bounding volume can be a simple 3D box with all normals of its faces pointing outward of the box. It can also be any other shapes such as a ball or other convenient forms to serve the same purpose. The method then removes the part of the scene inside the region connecting the scene camera and those front facing (with respect to the scene camera) part of the bounding volume.

(7) Dopesheet Window. The Dopesheet Window presents a frame-based view of animation tracks. An animation track represents the values that an animation variable (e.g. Position) takes in a time sequence. By entering values directly in the animation track or recording them through the Auto-key option, the user may add and manipulate animation for assets that are planted in the scene.
(8) Standard Menu. Besides the iconic representation of the functions and options as presented in the above, the user can use the standard drop down menus that have the same functionalities. For example, changing of active level can be done through hotkeys or by selecting the menu options that performs the same. Other standard operations such as loading, saving and help may be included in the standard menu.

### Scenario Planning/Monitoring

For a particular Scene, various Scenarios can be set up either to simulate and analyze hypothetical situations, or to replicate a real-world situation. As mentioned, a library of Scenario Objects is provided in the Asset Picker Control where the user can pick and place instances of these objects as assets in the Scene, and can animate them where needed.

To add an asset to the Scene, the user can first set the Active Level to the level the user wishes to place the new asset. Next, the user selects a category of objects by choosing from the dropdown list in the Asset Picker Control. Then, the user left-click with the mouse on the object the user wishes to instantiate and drag it into the Main View. With these steps, the asset appears in the Scene on the Active Level, and is added to the currently selected Group in the Assets Control. The user can also name the newly created asset by overwriting the default name in the Assets Control. Each asset is defined in its X-, Y-, and Z-axis, with Y-axis pointing upright.

Assets in the Scene can be selected as an individual or as a part of a group to be relocated or rotated or animated. In one embodiment, an asset can be selected by a left-click with the mouse on the asset in the Main View or in the Assets Control, and a group of assets can be selected by a left-click with the mouse on an empty space and drag out a selection box to enclose the group of assets. Also, an asset or a group of assets can be added into or removed from existing selected assets.

Assets being selected can be deleted by, for example, pressing the Del key. Assets being selected can be moved horizontally by dragging the assets with the mouse, and moved vertically by holding down, for example, the Ctrl key while dragging the assets with the mouse. Assets being selected can be rotated along the Y-axis by holding down, for example, the Alt key while dragging the assets with the mouse. Similarly, assets being selected can be rotated along the X-axis (and Z-axis, respectively) by holding down, for example, both the Ctrl and Alt (and Shift and Alt, respectively) keys while dragging the assets with the mouse.

Each Scenario created can be saved in digital media as a continuing planning or monitoring process. It can serve as lesson plan too for training purposes related to the primary building.

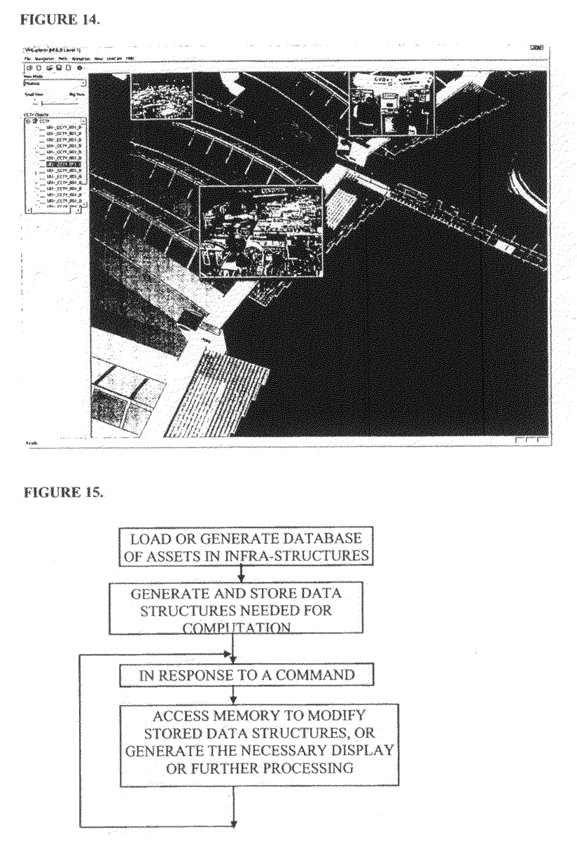

In replicating a real-world situation, assets can be linked directly to real-world devices such as temperature monitoring devices, CCTVs or position tracking devices to receive signals of the current status of the assets in the real-world. In the case of an asset linking to a temperature monitoring system, the view captured by the Scene Camera in the Main view can be augmented with a display of the temperature received. In the case of an asset linking to a CCTV, the view captured by the Scene Camera in the Main View can be augmented with the real-time images as captured by the CCTV (as shown in FIG. 14). In the case of an asset linking to a position tracking device, the view captured by the Scene Camera in the Main View can be updated to reflect the current position of the asset in the real-world. Furthermore, signals receive from one asset may be re-directed to another assets where appropriate.

### OPERATION OF THE METHOD OF THE EXAMPLE EMBODIMENT

FIG. 15 is a flowchart that depicts the operation of the method of the invention in planning, monitoring and exploring buildings. First, the system loads the Scene containing the buildings for planning, monitoring and exploring. The system also loads and generates the necessary data structures needed for computation, such as those assets in the Asset Picker Control and markers in the scene for path planning. At this point, the system is ready to begin an interactive display session with a user.

For planning application, a user can issue command to load a scenario previously created with the system or can start issuing commands to interactively create, experiment, and save a scenario. For monitoring application, a user can issue command to load a scenario to track assets in the Scene. The system may be a part of the command and control system where the user can communicate with assets and to command and control the transmission of signals among assets. For exploring application, a user can issue command to locate assets in the Scene.

The example embodiment described herein overcomes the limitations of the prior works and seeks to facilitate user control in planning, monitoring and exploring buildings. It utilizes 3D representation of a Scene to achieve a user-friendly GUI and even an amateur user of the system can use it with little training. The technical uniqueness of our invention lies in optimizing the limited screen space to provide an important set of tools to make user control easy.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A method of processing and displaying a scene of infra-structures and their vicinity utilizing a computer, the method comprising a graphical user interface (GUI) to support users in planning, monitoring and exploring the infra-structures wherein said GUI consists of the following major views and functions available to users:
a. Main View displaying the view of the scene as seen with the scene camera;
b. A collection of options in setting levels, layers, assets and generally resources of infra-structures to be captured by the scene camera;
c. A collection of tools in setting, experimenting and saving a scenario, containing assets planted in the scene;
d. A collection of tools to do measurements and scribble notes into a scenario or scene;
e. A collection of tools to cull away a part of the scene so that the scene camera can present views in the Main View to focus on interested areas that are normally not available with a standard camera; and
f. A collection of tools to plan and simulate animation of assets.

2. The method as claimed in claim 1 wherein the Main View in the GUI can incorporate a 2D floor plan of the scene and/or specialized plug-in menu in part of the Main View.

3. The method as claimed in claim 1 wherein the Main View can be navigated in an orbit mode, flight mode, and first-person mode.

4. The method as claimed in claim 1 wherein the Main View further provides options to query the assets, levels, layers, and generally resources in the scene.

5. The method as claimed in claim 1 wherein the options in setting level can toggled on and off, respectively, individual level of infra-structures to show and hide, respectively, the level from the scene camera.

6. The method as claimed in claim 1 wherein the options in setting level further include the step to allow the selection of active level that is currently the focus of the user's inspection and editing of the scenario where planting of new assets, scribbling, and first-person navigation take place.

7. The method as claimed in claim 1 wherein the options in setting layer can toggled on and off, respectively, individual layer of infrastructures to show and hide, respectively, the layer from the scene camera.

8. The method as claimed in claim 1 wherein the options in setting assets can name and organize assets into groups or hierarchical of groups.

9. The method as claimed in claim 1 wherein the options in setting assets can move the scene camera to target at an asset by clicking on the name representing the asset.

10. The method as claimed in claim 1 wherein the options in setting assets allow the deletion of asset through function key.

11. The method as claimed in claim 1 wherein the tools in setting up a scenario provide a library of scenario resources to be dragged into the Main View as assets in a scenario.

12. The method as claimed in claim 1 wherein the tools in setting up a scenario organize scenario resources into categories to allow ease of selection to be planted as assets in a scenario.

13. The method as claimed in claim 1 where assets, each as an individual or a few as a group, planted in a scene can be moved, rotated, or deleted by users.

14. The method as claimed in claim 1 wherein the tools in setting up a scenario provide options to query the assets, levels, layers and generally resources in the scene.

15. The method as claimed in claim 1 wherein the tools to scribble notes into a scenario or scene provide options to set the type of action, the type of brush, the type of color and strength, and the size of pen.

16. The method as claimed in claim 1 wherein the tools to cull away a part of the scene is a clipping tool.

17. The method as claimed in claim 1 wherein the tools to cull away a part of the scene is a spot tool.

18. The method as claimed in claim 1 wherein the tools to plan and simulate animation of assets further include a step to link (or map) assets directly to real-world devices to receive signals of the current status of the assets in the real-world for display in the Main View.

19. The device as mentioned in claim 18 can be a temperature monitoring device that captures real-time temperature of a physical location as signal.

20. The device as mentioned in claim 18 can be a CCTV that captures real-time image as signal.

21. The device as mentioned in claim 18 can be a position tracking device that provides real-time location of an asset as signal.

22. The method as claimed in claim 1 further includes the step to receive signal from one asset and in turn transmit the signal to another asset.

23. A system for processing and displaying a scene of infra-structures and their vicinity utilizing a computer, the system comprising a processor unit for displaying a graphical user interface (GUI) to support users in planning, monitoring and exploring the infrastructures wherein said GUI consists of the following major views and functions available to users:
a. Main View displaying the view of the scene as seen with the scene camera;
b. A collection of options in setting levels, layers, assets and generally resources of infra-structures to be captured by the scene camera;
c. A collection of tools in setting, experimenting and saving a scenario, containing assets planted in the scene;
d. A collection of tools to do measurements and scribble notes into a scenario or scene;
e. A collection of tools to cull away a part of the scene so that the scene camera can present views in the Main View to focus on interested areas that are normally not available with a standard camera; and
f. A collection of tools to plan and simulate animation of assets.

24. A data storage medium having stored thereon computer code means for instructing a computer to execute a method of processing and displaying a scene of infra-structures and their vicinity utilizing a computer, the method comprising a graphical user interface (GUI) to support users in planning, monitoring and exploring the infra-structures wherein said GUI consists of the following major views and functions available to users:
a. Main View displaying the view of the scene as seen with the scene camera;
b. A collection of options in setting levels, layers, assets and generally resources of infrastructures to be captured by the scene camera;
c. A collection of tools in setting, experimenting and saving a scenario, containing assets planted in the scene;
d. A collection of tools to do measurements and scribble notes into a scenario or scene;
e. A collection of tools to cull away a part of the scene so that the scene camera can present views in the Main View to focus on interested areas that are normally not available with a standard camera; and
f. A collection of tools to plan and simulate animation of assets.
